(19) United States
(12) Patent Application Publication
(10) Pub. No.: US 2021/0316527 A1
(43) Pub. Date: Oct. 14, 2021

(54) INTERLAYER AND ASSOCIATED REINFORCEMENT STRUCTURE, COMPOSITE, AND METHOD

(71) Applicant: The Boeing Company, Chicago, IL (US)

(72) Inventors: Benjamin P. Adamson, Melbourne (AU); George Holden, Melbourne (AU); Christopher A. Howe, Melbourne (AU)

(73) Assignee: The Boeing Company, Chicago, IL (US)

(21) Appl. No.: 16/843,423

(22) Filed: Apr. 8, 2020

(51) Int. Cl. B32B 5/08; B32B 5/02

(52) U.S. Cl. CPC B32B 5/08; B32B 5/022; B32B 2262/0253; B32B 2262/0276; B32B 2270/00

(57) ABSTRACT

An interlayer including a plurality of first thermoplastic filaments having a first melting temperature and a plurality of second thermoplastic filaments having a second melting temperature, wherein the second melting temperature is substantially greater than the first melting temperature.

### FIELD

This application relates to composites and, more particularly, to interlayer toughening of fiber-reinforced polymer-matrix composites, such as carbon fiber-reinforced plastics.

### BACKGROUND

Fiber-reinforced polymer-matrix composites, such as carbon fiber-reinforced plastics, tend to exhibit high strength at relatively light weight. Therefore, such fiber-reinforced polymer-matrix composites are commonly used for various applications (e.g., structural applications) throughout the aerospace industry, as well as in other industries (e.g., automotive and marine).

It has been known for some time that fiber-reinforced polymer-matrix composites can be enhanced by incorporating interlayers between the reinforcement layers of the reinforcement structure. For example, interlayers containing thermoplastic fibers are attached to dry carbon fiber reinforcement layers to increase the toughness of the resulting fiber-reinforced polymer-matrix composite, as well as to provide a more robust fabric to handle. Furthermore, the use of such interlayers also aids in the producibility of parts by allowing tacking of plies together as a layup aid.

Unfortunately, it can be difficult to control the extent of attachment of interlayers containing thermoplastic fibers to carbon fiber reinforcement layers. For example, an interlayer containing thermoplastic fibers can be attached to a carbon fiber reinforcement layer by passing both layers through a hot stage, then through a nip roller, and finally through a cooling stage. Depending on processing conditions and control, the extent of interlayer attachment may range from little/no attachment to a complete melting out of the thermoplastic fibers within the interlayer.

Accordingly, those skilled in the art continue with research and development efforts in the field of interlayer toughening of fiber-reinforced (e.g., carbon fiber-reinforced) polymer-matrix composites.

### SUMMARY

Disclosed is an interlayer. In one example, the disclosed interlayer includes a plurality of first thermoplastic filaments having a first melting temperature and a plurality of second thermoplastic filaments having a second melting temperature, wherein the second melting temperature is substantially greater than the first melting temperature.

Also disclosed is a reinforcement structure. In one example, the disclosed reinforcement structure includes an interlayer and a reinforcement layer at least partially connected to the interlayer, the interlayer including a plurality of first thermoplastic filaments having a first melting temperature and a plurality of second thermoplastic filaments having a second melting temperature, wherein the second melting temperature is substantially greater than the first melting temperature.

Also disclosed is a composite. In one example, the disclosed composite includes a reinforcement structure including a reinforcement layer and an interlayer adjacent the reinforcement layer, the interlayer including a plurality of first thermoplastic filaments having a first melting temperature and a plurality of second thermoplastic filaments having a second melting temperature, wherein the second melting temperature is at least 5° C. greater than the first melting temperature, and a matrix material incorporated into the reinforcement structure.

Also disclosed is a method for manufacturing a reinforcement structure for a composite, the reinforcement structure including an interlayer and a reinforcement layer. In one example, the disclosed method includes steps of: (1) contacting the reinforcement layer with the interlayer, the interlayer including a plurality of first thermoplastic filaments having a first melting temperature and a plurality of second thermoplastic filaments having a second melting temperature, wherein the second melting temperature is substantially greater than the first melting temperature; and (2) while the interlayer is in contact with the reinforcement layer, heating the interlayer to a temperature that is equal to or greater than the first melting temperature, but less than the second melting temperature, to at least partially connect the interlayer to the reinforcement layer.

Other examples of the disclosed interlayer and associated reinforcement structure, composite and method will become apparent from the following detailed description, the accompanying drawings and the appended claims.

### BRIEF DESCRIPTION OF THE DRAWINGS

FIG. 1 is a side cross-sectional view of one example of the disclosed interlayer;

FIG. 2 is a detailed side cross-sectional view of a portion of the interlayer shown in FIG. 1;

FIG. 3 is a plan view of a portion of the interlayer shown in FIG. 1;

FIG. 4 is a side cross-sectional view of an example of a reinforcement structure incorporating the interlayer of FIG. 1;

FIG. 5 is a plan view of a portion of the reinforcement structure of FIG. 4 showing the interlayer connected to an associated reinforcement layer;

FIG. 6 is a side cross-sectional view of a composite incorporating the reinforcement structure of FIG. 4;

FIG. 7 is a flow diagram depicting one example of the disclosed method for manufacturing a reinforcement structure, such as the reinforcement structure of FIG. 4;

FIG. 8 is a schematic representation of one example system for manufacturing a reinforcement structure, such as the reinforcement structure of FIG. 4;

FIG. 9 is a flow diagram of an aircraft manufacturing and service methodology; and

FIG. 10 is a block diagram of an aircraft.

### DETAILED DESCRIPTION

The following detailed description refers to the accompanying drawings, which illustrate specific examples of the disclosure. Other examples having different structures and operations do not depart from the scope of the present disclosure. Like reference numerals may refer to the same element or component in the different drawings.

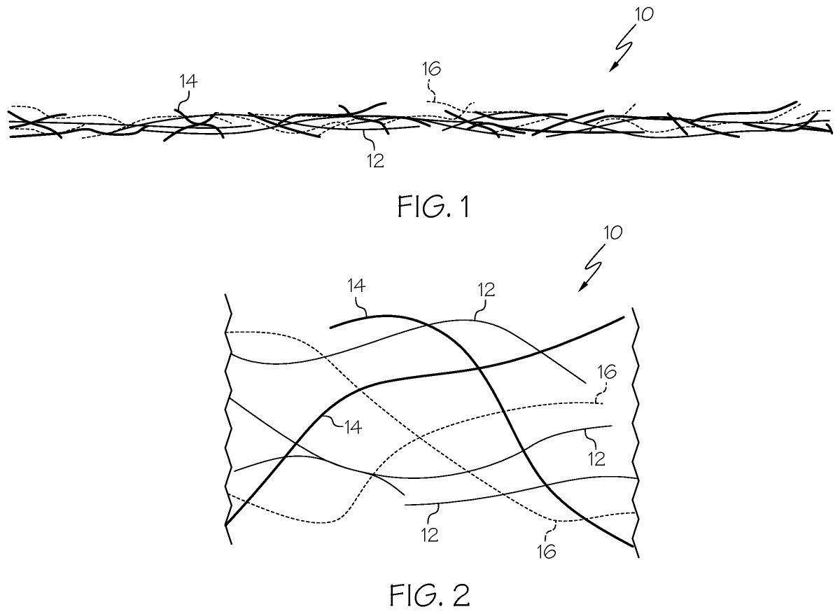

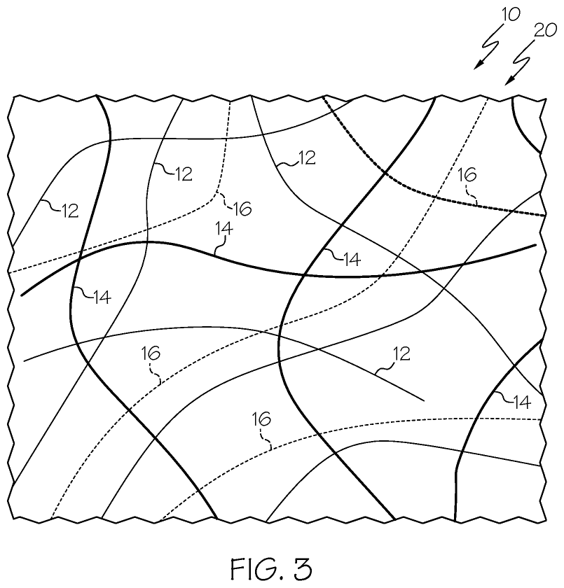

Referring to FIG. 1, one example of the disclosed interlayer, generally designated 10, is shown from a side cross-sectional view and includes a plurality of first thermoplastic filaments 12 and a plurality of second thermoplastic filaments 14. The first thermoplastic filaments 12 may be intermingled with the second thermoplastic filaments 14. As used herein, the term “intermingled” refers to the cohesion that occurs when filaments cross over other filaments and become entangled.

Optionally, the interlayer 10 may additionally include a plurality of non-thermoplastic filaments 16. The non-thermoplastic filaments 16 may be intermingled with the first thermoplastic filaments 12 and the second thermoplastic filaments 14.

Referring to FIGS. 1 and 3, the interlayer 10 may be configured in a variety of ways. In one example, the interlayer 10 may be configured as a nonwoven fabric 20. In another example, the interlayer 10 may be configured as one of a non-crimp fabric, a woven fabric, or a braided fabric. Other fabric configurations of the interlayer 10 are contemplated and may be used without departing from the scope of the present disclosure.

In one example, the interlayer 10 may have an areal weight from about 1 g/m² to about 20 g/m². In another example, the interlayer 10 may have an areal weight from about 2 g/m² to about 18 g/m². In yet another example, the interlayer 10 may have an areal weight from about 5 g/m² to about 15 g/m².

The first thermoplastic filaments 12 may have a melting temperature substantially lower than the second thermoplastic filaments 14. If a thermoplastic filament has a melting point range (i.e. 200-220° C.), the numerical value used to compare the difference in melting temperature is considered to be the midpoint of the melting point range (i.e. 200-220° C., the midpoint being 210° C.). In one example, a difference between the first melting temperature and the second melting temperature is at least 5° C. In another example, a difference between the first melting temperature and the second melting temperature is at least 10° C. In another example, a difference between the first melting temperature and the second melting temperature is at least 25° C. In another example, a difference between the first melting temperature and the second melting temperature is at least 50° C. In yet another example, a difference between the first melting temperature and the second melting temperature is at least 75° C.

The interlayer 10 may include different proportions of the first thermoplastic filaments 12 based on total weight of the interlayer 10. In one example, the first thermoplastic filaments 12 may comprise about 1 percent to about 60 percent of the interlayer 10. In another example, the first thermoplastic filaments 12 may comprise about 10 percent to about 50 percent of the interlayer 10. In yet another example, the first thermoplastic filaments 12 may comprise about 20 percent to about 40 percent of the interlayer 10.

The interlayer 10 may include different proportions of the first thermoplastic filaments 12 based on total volume of the interlayer 10. In one example, the first thermoplastic filaments 12 may comprise about 1 percent to about 60 percent of the interlayer 10. In another example, the first thermoplastic filaments 12 may comprise about 10 percent to about 50 percent of the interlayer 10. In yet another example, the first thermoplastic filaments 12 may comprise about 20 percent to about 40 percent of the interlayer 10.

The interlayer 10 may include different proportions of the first thermoplastic filaments 12 based on total surface area of the interlayer 10. In one example, the first thermoplastic filaments 12 may comprise about 1 percent to about 60 percent of the interlayer 10. In another example, the first thermoplastic filaments 12 may comprise about 10 percent to about 50 percent of the interlayer 10. In yet another example, the first thermoplastic filaments 12 may comprise about 20 percent to about 40 percent of the interlayer 10.

The interlayer 10 may include different proportions of the second thermoplastic filaments 14 based on total weight of the interlayer 10. In one example, the second thermoplastic filaments 14 may comprise about 1 percent to about 60 percent of the interlayer 10. In another example, the second thermoplastic filaments 14 may comprise about 10 percent to about 50 percent of the interlayer 10. In yet another example, the second thermoplastic filaments 14 may comprise about 20 percent to about 40 percent of the interlayer 10.

The interlayer 10 may include different proportions of the second thermoplastic filaments 14 based on total volume of the interlayer 10. In one example, the second thermoplastic filaments 14 may comprise about 1 percent to about 60 percent of the interlayer 10. In another example, the second thermoplastic filaments 14 may comprise about 10 percent to about 50 percent of the interlayer 10. In yet another example, the second thermoplastic filaments 14 may comprise about 20 percent to about 40 percent of the interlayer 10.

The interlayer 10 may include different proportions of the second thermoplastic filaments 14 based on total surface area of the interlayer 10. In one example, the second thermoplastic filaments 14 may comprise about 1 percent to about 60 percent of the interlayer 10. In another example, the second thermoplastic filaments 14 may comprise about 10 percent to about 50 percent of the interlayer 10. In yet another example, the second thermoplastic filaments 14 may comprise about 20 percent to about 40 percent of the interlayer 10.

The first thermoplastic filaments 12 may be selected from a variety of materials. In one example, the first thermoplastic filaments 12 may include at least one of polyamide, polyether ether ketone, polyether ketone, polyester, polyethersulfone, polyimide, polyurethane, polyolefin, polyethylene, polypropylene, polymethylpentene, polybutene-1, acrylic, poly(methyl methacrylate), nylon, and combinations thereof.

The second thermoplastic filaments 14 may be selected from a variety of materials. In one example, the second thermoplastic filaments 14 may include at least one of polyamide, polyether ether ketone, polyether ketone, polyester, polyethersulfone, polyimide, polyurethane, polyolefin, polyethylene, polypropylene, polymethylpentene, polybutene-1, acrylic, poly(methyl methacrylate), nylon, and combinations thereof.

The non-thermoplastic filaments 16 may include at least one of thermoset fibers, carbon nanotubes, glass fibers, ceramic fibers, and metallic fibers. Other similar types of fibers are contemplated and may be used without departing from the scope of the present disclosure.

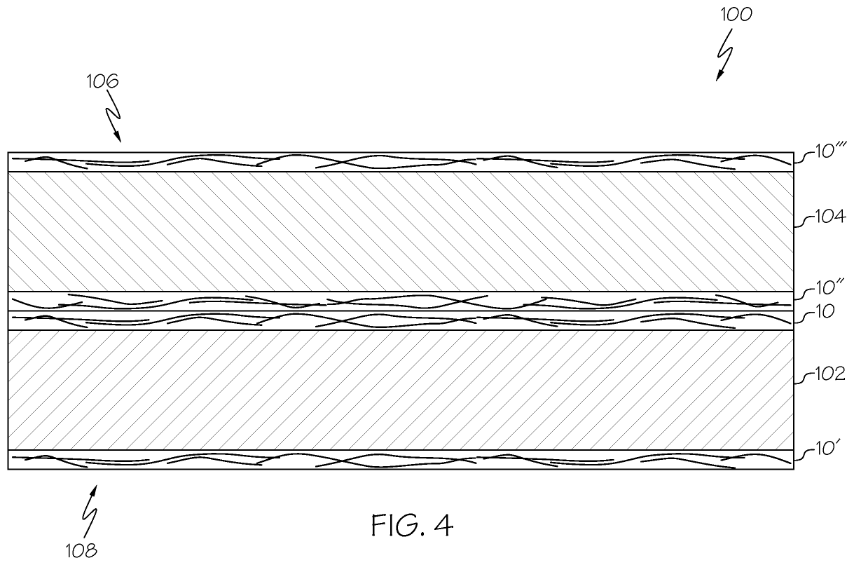

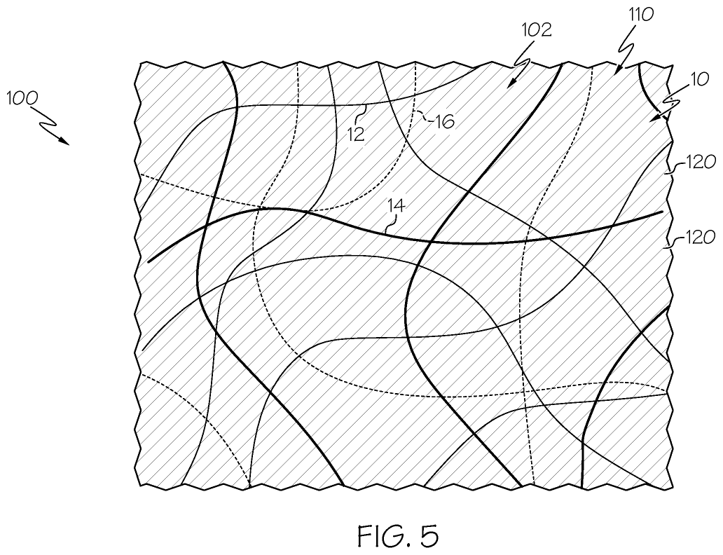

Referring to FIG. 4, one example of a reinforcement structure, generally designated 100, is shown from a side cross-sectional view. The reinforcement structure 100 includes multiple reinforcement layers, such as two reinforcement layers 102, 104. The reinforcement structure 100 may further include the interlayer 10, a second interlayer 10′ and a reinforcement layer 102 at least partially connected to at least one of the interlayer 10 and the second interlayer 10′. For example, the reinforcement layer 102 may be positioned between the interlayer 10 and the second interlayer 10′, and the reinforcement layer 102 may be at least partially connected to both the interlayer 10 and the second interlayer 10′. The reinforcement structure 100 may also include a third interlayer 10″, a fourth interlayer 10′″ and a second reinforcement layer 104 at least partially connected to at least one of the third interlayer 10″ and the fourth interlayer 10′″. The makeup of interlayer 10 also may describe the makeup of the second interlayer 10′, the third interlayer 10″ and the fourth interlayer 10′″.

At this point one skilled in the art will appreciate that many variations of the reinforcement structure 100 in FIG. 4 exist. As shown in FIG. 4, the reinforcement structure 100 may include a plurality of the reinforcement layers 102, 104 and a plurality of the interlayers 10, 10′, 10″, 10′″. Therefore, there may be at least two interlayers 10, 10″ between the reinforcement layers 102, 104 and at least one interlayer e.g., 10′, 10′″ may be on at least one of an exterior surface 106 and an interior surface 108 of the reinforcement structure 100. Of course, in other variations, only a single interlayer 10 may be positioned between adjacent reinforcement layers 102, 104.

At this point, those skilled in the art will appreciate that each layer of the reinforcement structure 100 may vary in thickness while maintaining functionality without departing from the scope of the present disclosure.

Referring to FIG. 5, shown in plan view is one example of a portion of the reinforcement structure 100 of FIG. 4, wherein the interlayer 10 is connected to an associated reinforcement layer 102. In one particular example, the reinforcement layer 102 may be configured as a unidirectional fabric 110. In another particular example, the reinforcement layer 102 may be configured as one of a non-crimp fabric, a woven fabric, and a braided fabric. In yet another particular example, the reinforcement layer 102 may be a dry reinforcement layer.

In one example, the reinforcement layer 102 may include carbon fibers 120. In another example, the reinforcement layer 102 may include at least one of thermoset fibers, carbon nanotubes, glass fibers, ceramic fibers, and metallic fibers.

In one example, the first thermoplastic filaments 12 may be melt-bonded to the reinforcement layer 102 and the second thermoplastic filaments 14 may not be melt-bonded to the reinforcement layer 102.

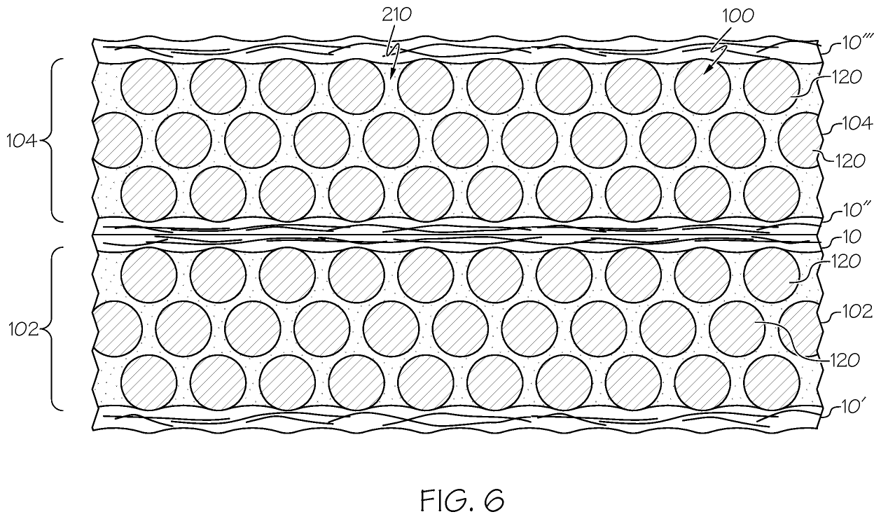

Referring to FIG. 6, shown in side cross-sectional view is one example of a composite 200 in accordance with the present disclosure. The composite 200 incorporates the reinforcement structure 100 previously described in FIG. 4. In addition to the reinforcement structure 100, the composite 200 may further include a matrix material 210 that encapsulates the reinforcement structure 100. In one example, the matrix material 210 may include a thermoset resin. In another example, the matrix material 210 may include an epoxy.

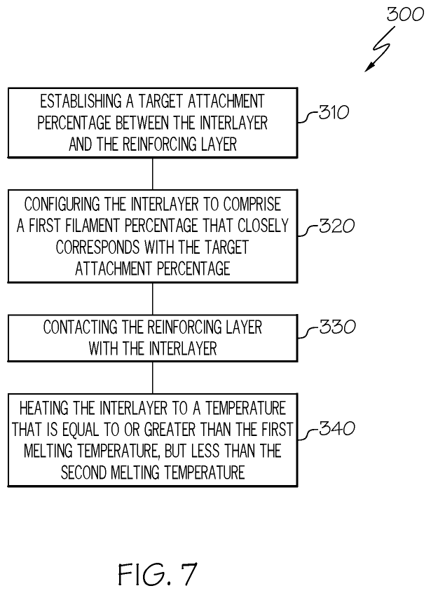

Referring to FIG. 7, a flow diagram is shown depicting one example of the disclosed method for manufacturing a reinforcement structure, such as the reinforcement structure of FIG. 4. The method 300 for manufacturing a reinforcement structure 100 for a composite 200 may include establishing 310 a target attachment percentage between the interlayer 10 and the reinforcement layer 102. The establishing 310 may be performed prior to the other steps shown in FIG. 7.

The method 300 may also include configuring 320 the interlayer 10 to include a percentage of a first plurality of thermoplastic filaments 12 that closely corresponds with the target attachment percentage. The first filament percentage is a percentage of the plurality of first thermoplastic filaments 12 within the interlayer 10 based on one of a total weight, total volume, or total surface area of the interlayer 10.

The method 300 may also include contacting 330 the reinforcement layer 102 with the interlayer 10.

Finally, the method 300 may include heating 340 the interlayer 10 to a temperature that is equal to or greater than the first melting temperature, but less than the second melting temperature, to at least partially connect the interlayer 10 to the reinforcement layer 102.

In one example, configuring 320 the interlayer 10 such that the first filament percentage closely corresponds with the target attachment percentage includes configuring 320 the interlayer 10 such that the first filament percentage equals the target attachment percentage.

In one example, the contacting 330 may include pressing the interlayer 10 into the reinforcement layer 102. In another example, the contacting 330 and the heating 340 may be performed simultaneously.

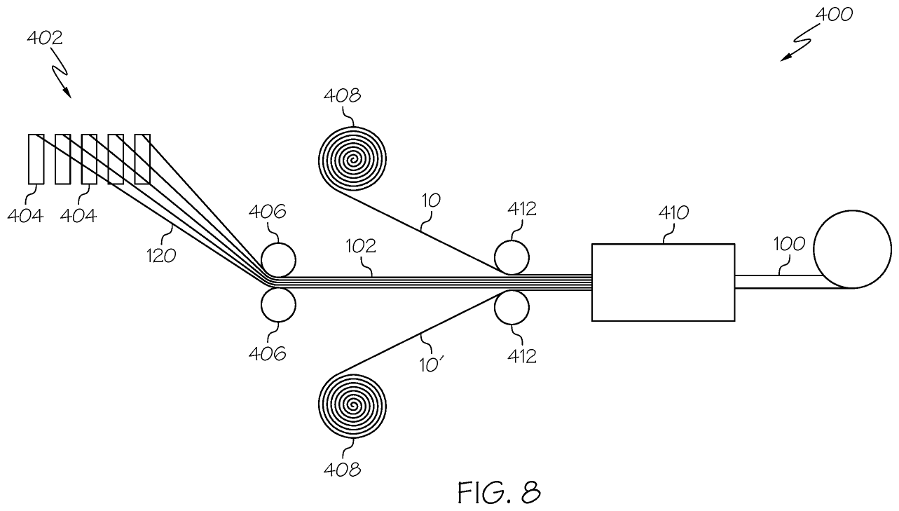

Referring to FIG. 8, is a schematic representation of one example system for manufacturing a reinforcement structure 100, such as the reinforcement structure 100 of FIG. 4. In one example of the disclosed system, generally designated 400, the reinforcement layers 102 may be prepared by laminating in which reinforcement fibers 120 are taken from a creel 402 containing multiple spools 404 of reinforcement fiber 120 (e.g., carbon fibers) that are spread to the desired width by spreader bars 406 and combined with the interlayers 10. A device, such as a laminator or horizontal oven combined with pressure rollers may be used to prepare the reinforcement layers 102 by providing tows of unidirectional reinforcement fibers 120 (e.g., carbon fibers) and then laminating an interlayer 10, fed from rollers 408, to the reinforcement layer 102. The interlayers 10 may be melt-bonded to one or both sides of reinforcement layer 102 under heat and/or pressure to produce a reinforcement structure 100 having the interlayer 10 melt-bonded to the reinforcement layer 102, for example by an oven 410 and/or by passing between heat rollers 412.

The target attachment percentage between the interlayer 10 and the reinforcement layer 102 may be achieved by heating and/or pressure in an oven 410 at a temperature greater than the melting point of the first thermoplastic filaments 12. In one example for 40% attachment, 40% of the interlayer 10 by one of total weight, total volume, or total surface area, may be comprised of first thermoplastic filaments 12 having a substantially lower melting point than a plurality of second thermoplastic filaments 14. When the material moves through a laminator or horizontal oven with the temperature above the melting point of the first thermoplastic filaments 12 the desired attachment level of 40% will be achieved. The results of attachment may be observed using a magnifying device such as an optical microscope, a scanner, or a scanning electron microscope.

One skilled in the art will appreciate that varying polymers can be randomly distributed (i.e. no directionality) or purposefully distributed in a geometric pattern (i.e. grid or linear lines in one direction, etc.) to achieve the required performance characteristics of reinforcement, such as: drapability, thickness (per ply), preformability, permeability, robustness, etc. The thickness of the interlayer 10 and the reinforcement layer 102 may be variable so long as functionality is maintained.

A benefit of this technology is that it can bring about the benefit of higher lamination levels for mechanical properties without sacrificing per ply thickness or permeability. Typically, higher lamination levels have provided some benefit to the compressive properties of reinforcement due to a straightening effect on the carbon fibers. The negative of this is that the lamination level is usually higher than required to maintain permeability, drapeability and desired per ply thickness. Using this technology high pressure with some temperature can be used to straighten out the carbon fibers whilst not melting out the higher temperature thermoplastic components or non-melting components.

One theoretical, nonlimiting example of the disclosed interlayer and associated reinforcement structure, and composite is described herein. The theoretical example may include an interlayer comprising a plurality of first thermoplastic filaments and a plurality of second thermoplastic filaments. The first thermoplastic filament may be polymethyl methacrylate having a melt temperature range of 240-255° C. supplied by M. Holland Company in Northbrook, Ill. The second thermoplastic filament may be nylon 6/6 having a melt temperature range of 270-305° C. supplied by M. Holland Company. The composite may consist of CYCOM 5320-1 resin (supplied by Solvay US of Houston, Tex.) and T800S (supplied by Toray Composite Materials America, Inc. of Tacoma, Wash.) reinforcement fibers with the interlayers to form a reinforcement structure.

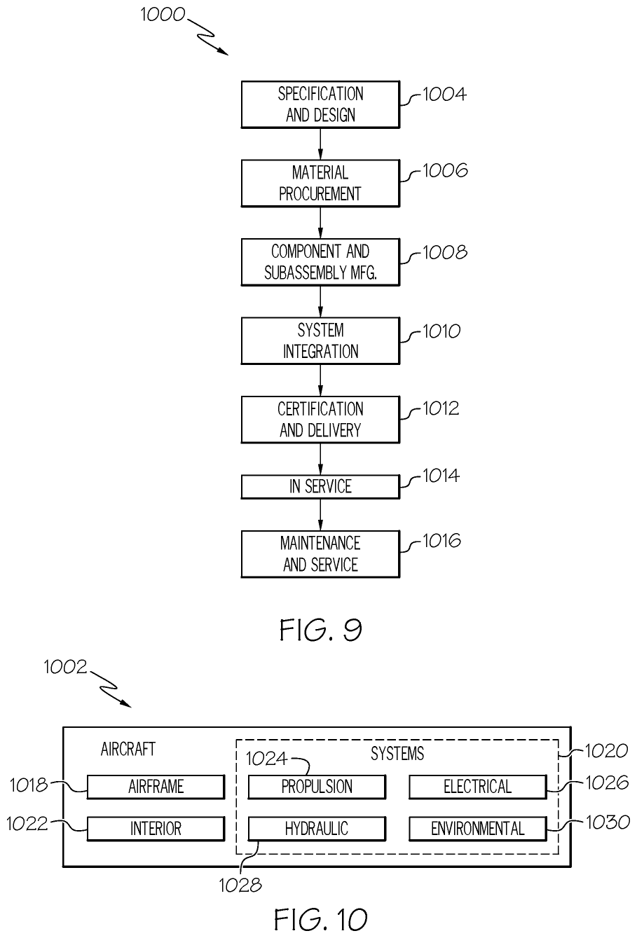

Examples of the disclosure may be described in the context of an aircraft manufacturing and service method 1000, as shown in FIG. 9, and an aircraft 1002, as shown in FIG. 10. During pre-production, the aircraft manufacturing and service method 1000 may include specification and design 1004 of the aircraft 1002 and material procurement 1006. During production, component/subassembly manufacturing 1008 and system integration 1010 of the aircraft 1002 takes place. Thereafter, the aircraft 1002 may go through certification and delivery 1012 in order to be placed in service 1014. While in service by a customer, the aircraft 1002 is scheduled for routine maintenance and service 1016, which may also include modification, reconfiguration, refurbishment and the like.

Each of the processes of method 1000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 10, the aircraft 1002 produced by example method 1000 may include an airframe 1018 with a plurality of systems 1020 and an interior 1022. Examples of the plurality of systems 1020 may include one or more of a propulsion system 1024, an electrical system 1026, a hydraulic system 1028, and an environmental system 1030. Any number of other systems may be included.

The disclosed interlayer and associated reinforcement structure, composite, and method may be employed during any one or more of the stages of the aircraft manufacturing and service method 1000. As one example, the disclosed reinforcement structure and composite may be employed during material procurement 1006. As another example, components or subassemblies corresponding to component/subassembly manufacturing 1008, system integration 1010, and or maintenance and service 1016 may be fabricated or manufactured using the disclosed reinforcement structure and composite. As another example, the airframe 1018 and the interior 1022 may be constructed using the disclosed reinforcement structure. Also, one or more apparatus examples, method examples, or a combination thereof may be utilized during component/subassembly manufacturing 1008 and/or system integration 1010, for example, by substantially expediting assembly of or reducing the cost of an aircraft 1002, such as the airframe 1018 and/or the interior 1022. Similarly, one or more of system examples, method examples, or a combination thereof may be utilized while the aircraft 1002 is in service, for example and without limitation, to maintenance and service 1016.

The disclosed interlayer and associated reinforcement structure, composite, and method are described in the context of an aircraft; however, one of ordinary skill in the art will readily recognize that the disclosed interlayer and associated reinforcement structure, composite, and method may be utilized for a variety of applications. For example, the disclosed interlayer and associated reinforcement structure, composite, and method may be implemented in various types of vehicles, including, for example, helicopters, passenger ships, automobiles and the like.

Although various examples of the disclosed interlayer and associated reinforcement structure, composite and methods have been shown and described, modifications may occur to those skilled in the art upon reading the specification. The present application includes such modifications and is limited only by the scope of the claims.

1. An interlayer comprising:
a plurality of first thermoplastic filaments having a first melting temperature; and
a plurality of second thermoplastic filaments having a second melting temperature,
wherein:
the second melting temperature is substantially greater than the first melting temperature;
the plurality of first thermoplastic filaments forms a first percentage of the interlayer and the plurality of second thermoplastic filaments forms a second percentage of the interlayer; and
the first percentage of the plurality of first thermoplastic filaments is approximately equal to a target attachment percentage of the interlayer to be melt-bonded to a reinforcement layer at a temperature that is equal to or greater the first melting temperature and that is less than the second melting temperature.

2. The interlayer of claim 1 wherein the plurality of first thermoplastic filaments are intermingled with the plurality of second thermoplastic filaments.

3. The interlayer of claim 1 wherein each first thermoplastic filament of the plurality of first thermoplastic filaments comprises a member selected from the group consisting of polyamide, polyether ether ketone, polyether ketone, polyester, polyethersulfone, polyimide, polyurethane, polyolefin, polyethylene, polypropylene, polymethylpentene, polybutene-1, acrylic, poly(methyl methacrylate), nylon, and combinations thereof.

4. The interlayer of claim 1 wherein each second thermoplastic filament of the plurality of second thermoplastic filaments comprises a member selected from the group consisting of polyamide, polyether ether ketone, polyether ketone, polyester, polyethersulfone, polyimide, polyurethane, polyolefin, polyethylene, polypropylene, polymethylpentene, polybutene-1, acrylic, poly(methyl methacrylate), nylon, and combinations thereof.

5. The interlayer of claim 1 wherein a difference between the first melting temperature and the second melting temperature is at least 5° C.

6. The interlayer of claim 1 wherein a difference between the first melting temperature and the second melting temperature is at least 10° C.

7-9. (canceled)

10. The interlayer of claim 1 having an areal weight from about 1 g/m² to about 20 g/m².

11. The interlayer of claim 1 having an areal weight from about 2 g/m² to about 18 g/m².

12. (canceled)

13. The interlayer of claim 1 wherein the first percentage of the plurality of first thermoplastic filaments comprises about 1 percent to about 60 percent of the interlayer based on one of a total weight of the interlayer, a total volume of the interlayer, and a surface area of the interlayer.

14. (canceled)

15. The interlayer of claim 1 wherein the second percentage of the plurality of second thermoplastic filaments comprises about 1 percent to about 60 percent of the interlayer based on one of a total weight of the interlayer, a total volume of the interlayer, and a surface area of the interlayer.

16. (canceled)

17. The interlayer of claim 1 further comprising a plurality of non-thermoplastic filaments.

18. The interlayer of claim 17 wherein the plurality of non-thermoplastic filaments are intermingled with the plurality of first thermoplastic filaments and the plurality of second thermoplastic filaments.

19. (canceled)

20. The interlayer of claim 1 configured as a nonwoven fabric.

21. A reinforcement structure comprising:
the interlayer of claim 1; and
a reinforcement layer that is melt-bonded to the interlayer at the target attachment percentage.

22. The reinforcement structure of claim 21 wherein the plurality of first thermoplastic filaments are melt-bonded to the reinforcement layer, and wherein the plurality of second thermoplastic filaments are not melt-bonded to the reinforcement layer.

23. The reinforcement structure of claim 21 further comprising a second interlayer, wherein the reinforcement layer is positioned between the interlayer and the second interlayer, and wherein the reinforcement layer is at least partially connected to the second interlayer.

24. The reinforcement structure of claim 23 wherein the second interlayer comprises:
a plurality of first thermoplastic filaments having a first melting temperature; and
a plurality of second thermoplastic filaments having a second melting temperature, wherein the second melting temperature is substantially greater than the first melting temperature.

25. The reinforcement structure of claim 21 wherein the reinforcement layer is configured as a unidirectional fabric.

26-29. (canceled)

30. A composite comprising:
a reinforcement structure comprising a reinforcement layer and an interlayer melt-bonded to the reinforcement layer at a target attachment percentage, the interlayer comprising:
a plurality of first thermoplastic filaments having a first melting temperature; and
a plurality of second thermoplastic filaments having a second melting temperature; and
a matrix material incorporated into the reinforcement structure,
wherein:
the second melting temperature is greater than the first melting temperature;
the plurality of first thermoplastic filaments forms a first percentage of the interlayer and the plurality of second thermoplastic filaments forms a second percentage of the interlayer based on one of a total weight of the interlayer, a total volume of the interlayer, and a surface area of the interlayer; and
the first percentage of the plurality of first thermoplastic filaments is approximately equal to the target attachment percentage of the interlayer for melt-bonding of the interlayer to the reinforcement layer at a temperature that is equal to or greater than the first melting temperature and that is less than the second melting temperature.

31-33. (canceled)

34. A method for manufacturing a reinforcement structure for a composite, the reinforcement structure comprising an interlayer and a reinforcement layer, the method comprising:
establishing a target attachment percentage of the interlayer to be melt-bonded to the reinforcement layer;
forming the interlayer comprising a first percentage of a plurality of first thermoplastic filaments having a first melting temperature and second percentage of a plurality of second thermoplastic filaments having a second melting temperature, wherein:
the second melting temperature is substantially greater than the first melting temperature; and
the first percentage of the plurality of first thermoplastic filaments is approximately equal to the target attachment percentage;
contacting the reinforcement layer with the interlayer; and
while the interlayer is in contact with the reinforcement layer, heating the interlayer to a temperature that is equal to or greater than the first melting temperature, but less than the second melting temperature, to melt-bond the interlayer to the reinforcement layer at the target attachment percentage.

35-38. (canceled)
